(19) United States
(12) Patent Application Publication
(10) Pub. No.: US 2003/0137984 A1
(43) Pub. Date: Jul. 24, 2003

(54) Transmission system for transmitting data from a plurality of peripheral devices to computer

(75) Inventor: Masahiro Nasu, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/342,515

(22) Filed: Jan. 15, 2003

(30) Foreign Application Priority Data
Jan. 18, 2002 (JP) 2002-009798

(51) Int. Cl. H04L 12/28

(52) U.S. Cl. 370/395.42; 370/235

(57) ABSTRACT

A priority is assigned for a keyboard and for a mouse. When the keyboard has a higher priority, a transmission number of the keyboard within one set (one repetition time Tk) is set to a greater number than the transmission number of the mouse. When the priority of the mouse is higher, the transmission number of the keyboard is set to a smaller number than that of the mouse. In this way, at least data of the device having a higher priority can be reliably transmitted. Only one set of data needs be transmitted, but the data need not be repeatedly transmitted a plurality of times as has been necessary in the prior art systems. Therefore, a transmission time required for transmitting all the data can be shortened.

### BACKGROUND OF THE INVENTION

1. Field of the Invention

This invention relates to a transmission system for transmitting data by using the same channel from a plurality of peripheral devices such as a mouse and a keyboard to an apparatus main body such as a computer, for example. The invention particularly relates to a transmission system that improves a transfer rate of a whole system.

2. Description of the Prior Art

Data transmission means from a plurality of peripheral devices such as a keyboard and a mouse to an apparatus main body such as a computer includes wire communication means that transmits data through dedicated cables, and wireless communication means that transmits data by using a radio wave such as an FM modulation wave or an optical signal such as infrared rays.

To have data reliably transmitted in both wire communication means and wireless communication means described above, it is desirable to change channels (frequency or wavelength) among discrete peripheral devices and to prevent interference of data among the channels.

However, this method is not realistic because the apparatus main body must be provided with reception means for each channel, and the size and cost of the apparatus main body inevitably increase.

Alternatively, it may be possible to employ a method that causes the apparatus main body to control a transmission timing of a plurality of peripheral devices. However, this method can be applied only to a bi-directional communication system in which the apparatus main body and the peripheral devices can conduct bi-directional communication, but not to a one-way communication system in which communication is made from only the peripheral devices to the apparatus main body.

It may be further possible to employ a method that, controls the transmission timing to the apparatus main body while the peripheral devices communicate with one another. This method is not realistic, either, because a transmitter and a receiver must be provided to each peripheral device.

Therefore, it has been customary in the past to conduct data transmission between the apparatus main body and a plurality of peripheral devices through the same channel as will be explained below.

FIG. 3 of the accompanying drawings shows an example of a timing chart of data transmission in the prior art system. A peripheral device A is a keyboard and a peripheral device B is a mouse. Symbols “a” to “d” represent data, and a suffix of each data represents a transmission sequence.

When any one of the keys of the keyboard is depressed, two data “a” and “b” corresponding to the key are transmitted in a predetermined transmission time t1 with a predetermined repetition time T1 as shown in FIG. 3.

When the mouse is operated, on the other hand, two data “c” and “d” corresponding to the operation of the mouse are transmitted in a predetermined transmission time t2 with the predetermined repetition time T1.

However, the transmission time t1 of the keyboard and the transmission time t2 of the mouse are so set as to be different from each other.

When the timing of the transmission data of the keyboard happens to be in synchronism with that of the transmission data of the mouse as shown in FIG. 3, their first data “a₁” and “c₁” and their first data “b₁” and “d₁” after the repetition interval T1 (=T2) overlap time-wise with one another, respectively, and generate interference. Therefore, the apparatus main body cannot receive the correct data.

On the other hand, because the timing of their second data is not coincident, their second data “a₂” and “c₂” and their second data “b₂” and “d₂” can be correctly received by the apparatus main body.

However, the transmission method according to the prior art is based on the premise that all the data transmitted from the keyboard and from the mouse are correctly received by the apparatus main body on the reception side. When an operator slightly moves the mouse while inputting the data through the keyboard, for example, the necessary data of the keyboard and the unnecessary data of the mouse are transmitted at the timing described above. Therefore, the transmission time required for the apparatus main body to receive the data gets elongated, and a substantial transfer rate gets retarded as a whole.

### SUMMARY OF THE INVENTION

To solve the problems of the prior art systems described above, the invention aims at providing a transmission system that assigns transmission priority for a peripheral device used at present and for a peripheral device not used, makes it possible to reliably transmit data of at least the peripheral device having a higher priority and can thus shorten an overall transmission time.

According to one aspect of the invention, there is provided a transmission system among a plurality of peripheral devices capable of data transmission through the same channel and an apparatus main body capable of receiving data through the channel, wherein each of the peripheral devices can transmit at least one transmission number of data contained in one set when a group of the same data contained in a repetition time from transmission of previous data to transmission of next data different from the previous data is defined as one set; and when one of the peripheral devices has a higher priority than the other of the peripheral devices, transmission is conducted while the transmission number inside one set having a higher priority is varied from the transmission number inside one set having a lower priority.

In this case, transmission is conducted by increasing the transmission number of the other peripheral device to a number greater than the transmission number of one of the peripheral devices when a priority of the other peripheral device is higher while the transmission number inside one set of one of the peripheral devices is kept constant, and by decreasing the transmission number of the other peripheral device to a number smaller than the transmission number of one of the peripheral devices when a priority of the other peripheral device is lower. The priority in this case is preferably set so that the peripheral device primarily used at present has a higher priority.

The invention divides an operation mode of the peripheral device into a mode in which fall-off of data is permitted and a mode in which the data fall-off is inhibited, assigns a higher priority for the operation mode in which data fall-off is inhibited and a lower priority for the operation mode in which data fall-off is permitted, sets the transmission number of the peripheral device having a higher priority to a number greater than that of the peripheral device having a lower priority and can thus shorten the transmission time of all the data.

Distinction between the operation mode in which data fall-off is permitted and the operation mode in which data fall-off is inhibited is preferably determined depending on which peripheral device is primarily used. In other words, a higher priority is preferably assigned for the peripheral device having a higher frequency of use at the present moment.

For example, one of the peripheral devices is a mouse as coordinates inputting means and the other peripheral device is a keyboard as character inputting means. In this case, the keyboard is provided with operation buttons. When the operation button is operated, a higher priority is preferably assigned for the keyboard than the mouse.

### BRIEF DESCRIPTION OF THE DRAWINGS

FIG. 1 is a schematic view showing a transmission system according to an embodiment of the invention;

FIG. 2 is a timing chart of a transmission system according to the invention, wherein symbol A represents the case where an operation mode of a keyboard is an inhibition mode but an operation mode of a mouse is a permission mode, and symbol B represents the case where the operation mode of the keyboard is the permission mode but the operation mode of the mouse is the inhibition mode; and

FIG. 3 shows an example of a timing chart of data transmission according to the prior art.

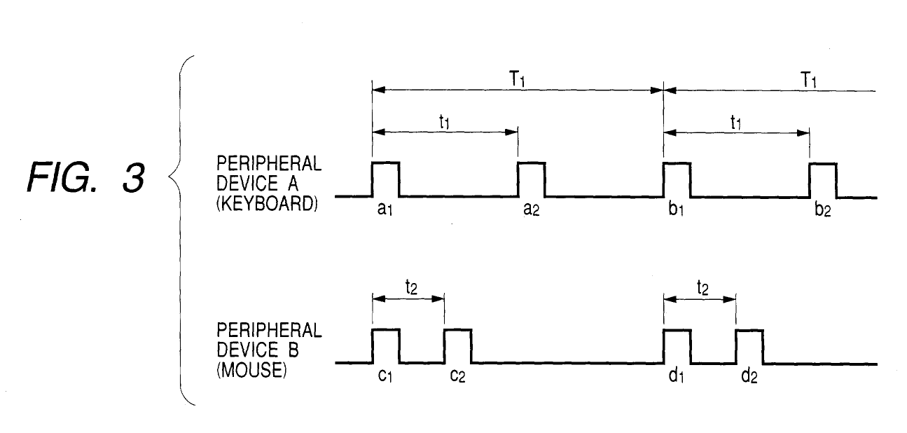

### DESCRIPTION OF THE PREFERRED EMBODIMENT

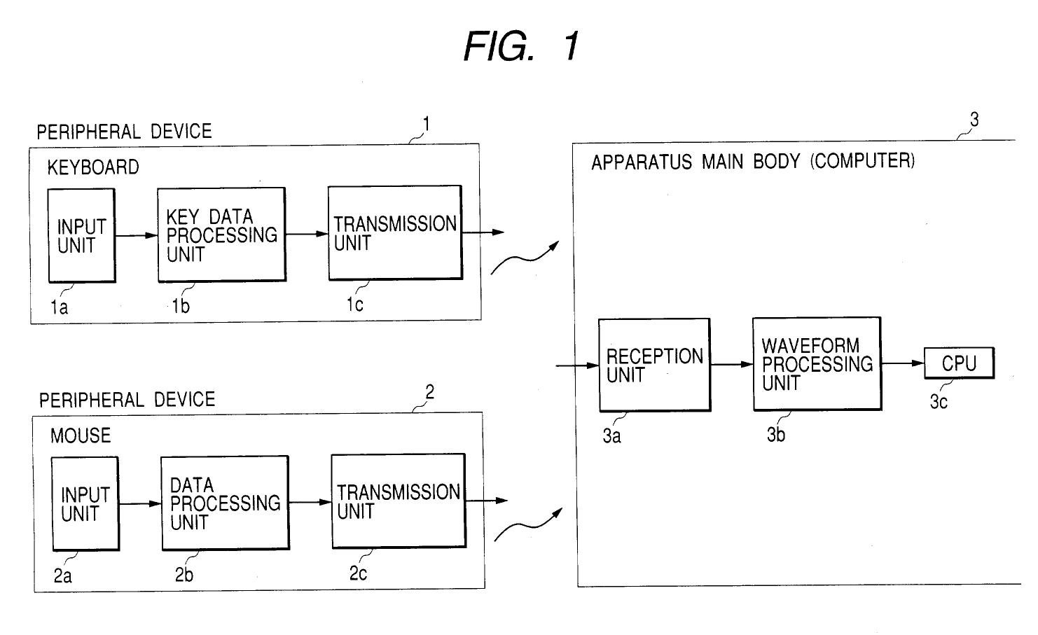

FIG. 1 is a schematic view showing a transmission system according an embodiment of the invention. In FIG. 1, a keyboard 1 and a mouse 2 as first and second peripheral devices are shown arranged on a transmission side and a computer 3 as an apparatus main body, on a reception side.

The keyboard 1 as the first peripheral device includes an input unit 1a having a plurality of operation keys, a key data processing unit 1b and a transmission portion 1c. The key data processing unit 1b converts an inputted operation key to predetermined key data. The transmission unit 1c executes predetermined processing for the key data outputted from the key data processing unit 1b and transmits the resulting data to the reception side.

The keyboard 1 has a dedicated operation button (not shown) for selecting priority of the keyboard 1. When this operation button is set to a lock state, for example, the priority of the keyboard 1 becomes higher than that of the mouse. When the operation button is set to a lock release state, the priority becomes lower, on the contrary. The operation button need not always be a dedicated operation button on the keyboard 1, but the priority may be set to a higher level when a plurality of buttons arbitrarily selected from inside the keyboard 1 is simultaneously selected. Alternatively, the priority may be set in accordance with the condition of use of the keyboard 1 such that the priority of the keyboard 1 becomes lower when one key is continuously depressed, and becomes automatically higher when the operation of other keys is made.

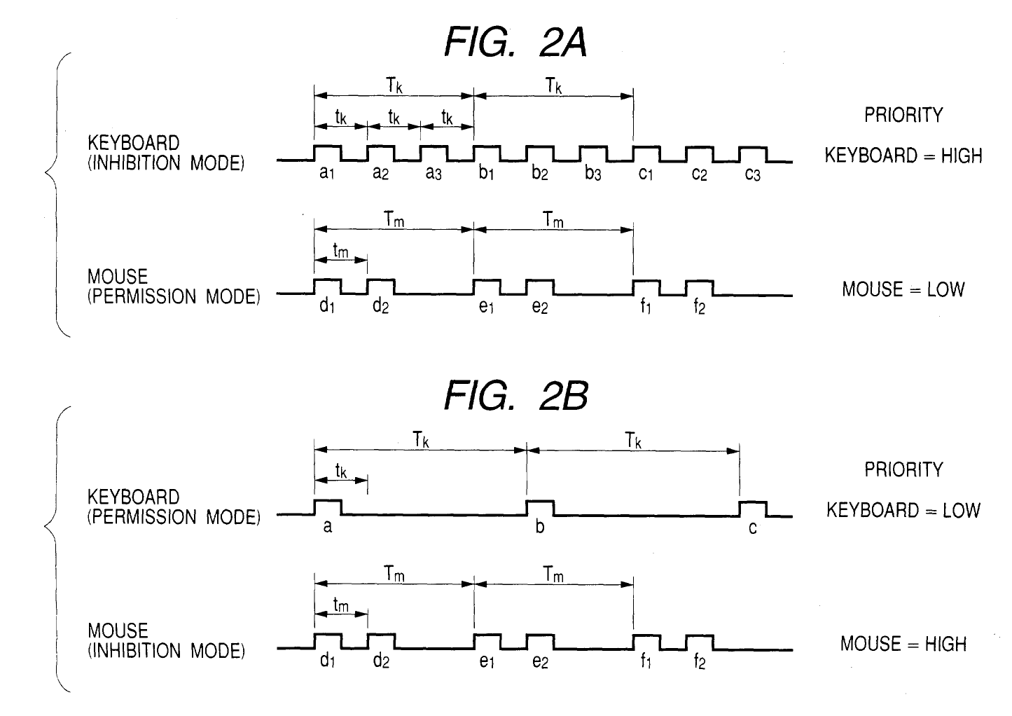

Similarly, the mouse 2 as the first peripheral device includes an input unit 2a, a data processing unit 2b and a transmission unit 2c. The input unit 2a includes a ball and an encoder, for example, and outputs a pulse in an X-Y direction with the movement of the mouse 2. The data processing unit 2b counts the pulse output, converts it to data, executes processing shown in later-appearing FIGS. 2A and 2B and outputs the data to the transmission unit 2c. The transmission unit 2c outputs the data outputted from the data processing unit 2b to the reception side.

Operation modes of the keyboard 1 and the mouse 2 in this embodiment are divided into a permission mode where fall-off of the data is permitted and an inhibition mode where fall-off of the data is inhibited. In other words, when either one of the keyboard 1 and the mouse 2 is in the permission mode, the other is set to the inhibition mode.

When the keyboard 1 is in the inhibition mode in this case, fall-off of the data during transmission between the keyboard 1 and the computer 3 is inhibited, but data fall-off between the mouse 2 and the computer 3 is permitted. When the keyboard 1 is in the permission mode, on the contrary, data fall-off is permitted between the keyboard 1 and the computer 3 but is inhibited between the mouse 2 and the computer 3.

When the operation button of the keyboard 1 is set to the lock state and the keyboard 1 is set to a higher priority than the mouse 2, for example, the keyboard 1 is set to the inhibition mode and the mouse 2, to the permission mode. When the lock state is released and the keyboard 1 is set to a lower priority than the mouse 2, the keyboard 1 is set to the permission mode and the mouse 2, to the inhibition mode.

On the other hand, the computer 3 as the apparatus main body side includes a reception unit 3a and can receive the data transmitted from the transmission unit 1c or 2c of the keyboard 1 or the mouse 2. The computer 3 shapes the waveform of the data the reception unit 3a receives, and supplies the data after waveform shaping to its internal CPU 3c.

Communication means between the transmission unit 1c or 2c of the keyboard 1 or the mouse 2 and the reception unit 3a of the computer 3 in this embodiment may be wire communication means using a dedicated cable or wireless communication means using radio wave signals such as an FM modulation wave or optical signals such as infrared rays. However, communication between the keyboard and the computer and communication between the mouse and the computer are executed by using the same channel (frequency or wavelength).

The transmission unit 1c or 2c in the case of wire communication means is a buffer circuit for output and the reception unit 3a is a buffer circuit for reception. The transmission unit 1c or 2c in the case of wireless communication means using the radio waves is a transmitter and the reception unit 3a is a receiver. The transmission unit 1c or 2c in the case of wireless communication means using the radio waves is a photo-diode and the reception unit 3a is a photo-transistor.

An operation in the invention will be explained hereinafter with reference to FIG. 2.

FIG. 2 shows a timing chart of a transmission system according to the invention. FIG. 2A shows the case where the operation mode of the keyboard is the inhibition mode but the operation mode of the mouse is the permission mode. FIG. 2B shows the case where the operation mode of the keyboard is the permission mode but that of the mouse is the inhibition mode.

Symbols “a” to “f” in FIGS. 2A and 2B represent the data transmitted from the keyboard 1 or the mouse 2 to the computer 3, and a suffix of each data represents the sequence of transmission. For example, the data “a₁”, “a₂” and “a₃” represent that the content of the data is the same.

As shown in FIGS. 2A and 2B, a transmission time required for the mouse 2 to transmit one data is represented by tₘ and a repetition time from previous transmission to next transmission (time required for transmitting one set of data), by Tₘ. The transmission number (number of times of transmission) of the mouse 2 is 2 (times) (twice for one set) within the repetition time Tₘ. For example, the repetition time Tₘ of the mouse is set to 39.9 msec and the transmission time tₘ, to 13.3 msec, and these values are kept always constant. The term “one set” used hereby represents a group of the same data contained within the repetition time Tₘ till transmission of next data different from the data previously transmitted.

When the keyboard 1 is set to the inhibition mode (priority=high) while the mouse is set to the permission mode (priority=low) as shown in FIG. 2A, the key data processing unit 1b of the keyboard 1 sets the transmission number of data transmitted from the keyboard 1 to 3 per one set (within one repetition time Tₖ). However, the repetition time Tₖ of the keyboard 1 and its transmission time tₖ are set to the same values as those of the repetition time Tₘ of the mouse and its transmission time tₘ, respectively (Tₖ=Tₘ and tₖ=tₘ).

When setting is made in the manner described above, the possibility becomes small that the computer 3 correctly receives the data of the mouse 2 even if the data of the keyboard 1 is synchronous with the data of the mouse 2 for the following reason. For, the first data “a₁”, “b₁” and “c₁” in one set of the keyboard 1 overlap and interfere time-wise with “d₁”, “e₁” and “f₁” of the first data in one set of the mouse 2 while “a₂”, “b₂” and “c₂” of the second data in one set of the keyboard 1 overlap and interfere time-wise with “d₂”, “e₂” and “f₂” of the second data in one set of the mouse 2, as shown in FIG. 2A.

Because the data of the mouse 2 does not exist at the remaining third data “a₃”, “b₃” and “c₃” of the keyboard 1, however, the reception unit 3a of the computer 3 can correctly receive the third data of the keyboard 1 without interference.

In other words, when the keyboard 1 is in the inhibition mode and the mouse 2 is in the permission mode, only the data of at least the keyboard 1 can be reliably transmitted to the computer 3.

Incidentally, when the data of the keyboard 1 is asynchronous with the data of the mouse 2, the possibility becomes small that the first to third data of the keyboard 1 overlap time-wise with the first and second data of the mouse 2. Therefore, the data of the keyboard 1 can be more reliably transmitted to the computer 3.

Next, when the keyboard 1 is set to the permission mode (priority=low) and the mouse 2, to the inhibition mode (priority=high) as shown in FIG. 2B, the data processing unit 1b of the keyboard 1 sets the transmission number of data transmitted from the keyboard 1 to 1 per set. However, the repetition time Tₖ of the keyboard 1 is set to a time somewhat longer than the repetition time Tₘ of the mouse 2 (for example, Tₘ=50 msec). The transmission time tₖ of the keyboard 1 is the same as the transmission time tₘ of the mouse 2 (tₖ=tₘ).

When setting is made as described above, the data of the mouse 2 can be reliably transmitted to the computer even when the data of the keyboard 1 is synchronous in some cases with the data of the mouse 2 as shown in FIG. 2B, for example. In other words, even when the data “a” of the keyboard 1 overlaps and interferes time-wise with the first data “d₁” of the mouse 2, the data of the keyboard 2 does not exist when the second data “d₂” of the mouse 2 is transmitted. In consequence, the computer 3 can receive the second data “d₂” of the mouse 2.

In the case of asynchronism, the data “b” of the keyboard 1 does not overlap time-wise with at least either one of the first and second data “e₁” and “e₂” of the mouse 2. Therefore, the computer 3 can receive the data that does not overlap.

When one data is transmitted, it is necessary in the invention to transmit only once one set of data as shown in FIGS. 2A and 2B. In other words, it is not necessary in the invention to transmit a plurality of times the data as has been necessary in the prior art system. Consequently, the transmission time required for transmitting all the data can be shortened.

As described above, the invention assigns priority for the peripheral devices and can reliably transmit the data of the peripheral device having a higher priority to the apparatus main body.

In this instance, the invention can substantially shorten the transmission time required for transmitting the data from the peripheral device to the apparatus main body.

What is claimed is:

1. A transmission system among a plurality of peripheral devices capable of data transmission through the same channel and an apparatus main body capable of receiving data through the same channel, wherein:
each of said peripheral devices can transmit at least one transmission number of data contained in one set when a group of the same data contained in a repetition time from transmission of previous data to transmission of next data different from the previous data is defined as one set; and
when one of said peripheral devices has a higher priority than other of said peripheral devices, transmission is conducted while the transmission number inside said one set having a higher priority is varied from the transmission number inside said one set having a lower priority.

2. A transmission system according to claim 1, wherein transmission is conducted by increasing said transmission number of said other peripheral device to a number greater than said transmission number of said one peripheral device when a priority of said other peripheral device is higher while said transmission number inside said one set of said one peripheral device is kept constant, and by decreasing said transmission number of said other peripheral device to a number smaller than said transmission number of said one peripheral device when a priority of said other peripheral device is lower.

3. A transmission system according to claim 1, wherein said priority is so set as to be higher for said peripheral device that is mainly used at present.

4. A transmission system according to claim 1, wherein said one peripheral device is a mouse as coordinates inputting means and said other peripheral device is a keyboard as character inputting means.

5. A transmission system according to claim 4, wherein operation buttons are provided to said keyboard, and a higher priority is assigned for said keyboard than said mouse when said operation buttons are operated.
